(19) United States
(12) Patent Application Publication
(10) Pub. No.: US 2014/0272004 A1
(43) Pub. Date: Sep. 18, 2014

(54) POCKET BREAD FOR SANDWICHES

(71) Applicant: N. Eric Porat, Mission Viejo, CA (US)

(72) Inventor: N. Eric Porat, Mission Viejo, CA (US)

(21) Appl. No.: 13/853,983

(22) Filed: Mar. 29, 2013

Related U.S. Application Data
(60) Provisional application No. 61/793,968, filed on Mar. 15, 2013.

(51) Int. Cl. A21D 13/00

(52) U.S. Cl. CPC A21D 13/0029
USPC 426/76

(57) ABSTRACT

A pita bread can advantageously be shaped and configured to be used as a sandwich bun, and more specifically as a hamburger or hot dog bun. Pita dough is first shaped in a manner to efficiently accommodate a hamburger patty or elongate hot dog, with associated fixings, within a pocket of the pita without substantial losses of fixings and without the bun breaking or disintegrating when being held by the eater. Pita shapes and configurations that employ the unique aspects of pita breads to create sturdy, clean and tasty sandwich buns are discussed and claimed. Embodiments may also include a perforation line enabling preferential tearing to remove an edge and reveal an opening providing access to the pita pocket.

### BACKGROUND

1. Field

The present invention is in the field of bread products, and more specifically relates to pocket breads such as pita bread.

2. Description of the Related Art

Hamburgers and hot dogs are among the most popular of sandwiches. Each year millions upon millions of such sandwiches are consumed at restaurants, sporting events, barbeques and homes across the United States.

Typically, a hamburger includes a circular bread bun having top and bottom portions that are separated from one another. A circular beef patty is arranged between the top and bottom bread bun portions along with various fixings such as condiments, cheese, pickles, lettuce, tomatoes, onions, and sometimes even more adventurous fixings such as mushrooms, guacamole and the like. The hamburger sandwich is held by a user grasping the top and bottom buns with one or both hands. Depending on what and how many fixings have been added, and also upon the sturdiness of the bread bun, fixings may leak or drip from the hamburger sandwich onto the eater's hands, clothes, plate or the surrounding area. As such, hamburgers can be very messy to eat, and often require the eater to use both hands just to keep the sandwich from falling apart.

Hot dog sandwiches also typically use a bread bun. Typically the hot dog bun is elongate so as to accommodate and support an elongate frankfurter/hot dog. In contrast to hamburgers, however, typically a hot dog bun is split so that top and bottom bun portions are hinged relative to one another at a side hinge portion. When the hot dog bun is opened, the top and bottom bun portions often lie side by side on either side of the hinge. The hot dog and fixings usually are added as the hot dog bun is in such a hinge-down and open orientation. Notably, often the top and bottom portions at least partially rip and separate from one another at the hinge portion in the process of opening the bun.

Several types of fixings are used with hot dogs, which may include such disparate fixings as conventional ketchup and mustard to onions and even chili and cheese. When fixings are piled onto the hot dog bun, the hinge may at least partially fail, causing fixings to drip and fall from the sandwich. Even if the hinge portion remains intact, however, the hot dog bun is open at each end. Thus, fixings often drip or fall over the ends and out of the sandwich.

Breads used to make sandwich buns such as hamburger and hot dog buns can also present problems, as such breads traditionally are light and airy, and may be subject to failure under the forces of the user holding the bun and simultaneously biting and ripping away portions of the bun and fixings as the sandwich is eaten.

### SUMMARY

Accordingly, there is a need in the art for a hamburger sandwich in which the bun portion can hold the hamburger patty and fixings so as to avoid or minimize the likelihood of dripping during the process of eating a hamburger. There is also a need in the art for a hot dog sandwich in which the bun portion similarly contains or minimizes drippings or escape of fixings, even when fixings are piled high.

There is a further need in the art for a sandwich bun that is sufficiently sturdy to endure the rigors of being held tightly in an eater's hand(s) while portions of the bun and sandwich are ripped off during eating.

Flatbreads such as pita bread have become more popular in recent years, as these types of breads tend to be more healthy than typical sandwich bread products. The U.S. populace also is coming to better appreciate the flavor and texture of pocket-type breads such as pita breads.

During baking, pocket breads, broadly referred to herein as pita breads, inflate due to heating of steam within the bread. This results in the baked pita bread having an internal pocket that can be accessed when the bread is ripped open. Typically, however, pita breads are made having a circular shape that accommodates sandwich types such as gyros, but does not fit well for other sandwich types such as hamburgers and hot dogs. As such, there is a need in the art for pita bread-based sandwich buns that are shaped and configured to accommodate and fit meats and fixings for hamburger and hot dog sandwiches.

In accordance with one embodiment, a pocket bread is disclosed comprising a circumferential edge surrounding a flatbread body. A pocket is formed within the flatbread body. The circumferential edge comprises an arcuate bottom edge portion, opposing first and second side edge portions extending from opposing ends of the arcuate bottom edge portion, and a top edge portion connecting the opposing side edges. The arcuate bottom edge portion curves up to 180° about an axis and has a radius. There is a perforation line adjacent the top edge portion and extending from the first side edge portion to the second side edge portion. The pocket bread preferentially tears along the perforation line to form an opening providing access to the pocket within the body. A minimum distance from the axis to the perforation line is at least as great as the radius of the arcuate bottom edge portion.

In some embodiments, the first and second side edge portions are parallel. But in other embodiments, the first and second side edge portions are divergent moving in a direction toward the top edge portion. In some embodiments the top edge portion is flat. But in other embodiments, the top edge portion is arcuate, and the perforation line is correspondingly arcuate.

In additional embodiments a stress concentration point is located at the intersection of one of the first and second side edge portions at the perforation line. In some such embodiments a notch is formed in one of the first and second side edge portions and aligned with the perforation line, and the stress concentration point is at the notch.

In further embodiments a tab portion extends outwardly from one of the first and second side edge portions between the perforation line and the top edge portion. In some such embodiments a bottom edge of the tab portion is generally aligned with the perforation line.

In yet additional embodiments a tear-off portion is defined between the perforation line and a tear-off edge, and the perforation line is aligned with one of the side, bottom and top edge portions, and an offset extends from the respective one of the side, bottom and top edge portions and the tear-off edge.

Some embodiments may not have a perforation line, or may have only a perforation that is not formed into a line, or a line that extends only partially across the pita bread. In such embodiments the user may still tear off an edge such as the top edge to form an opening providing access to the pocket within the body.

In other embodiments, the pocket bread is cut adjacent the top edge so as to form the opening. Such cutting can be performed by an end user, or can be performed during manufacture. For example, in some embodiments, a plurality of pocket breads are stacked and aligned and then cut adjacent the top edge so as to form the opening. The pocket breads may then be placed in packages so that the end user has a pocket bread in which an edge has already been removed, leaving an opening allowing the end user to insert sandwich fixings into the pocket.

In accordance with another embodiment a pocket bread is provided comprising an elongate flatbread body having a circumferential edge extending about the elongate body, a pocket being formed within the elongate flatbread body. The circumferential edge comprises a first end, a second end, a top edge and a flat bottom edge. A perforation line is adjacent the top edge and extends from the first end to the second end. A tear-off portion is defined between the perforation line and the top edge. The pocket bread preferentially tears along the perforation line so that the tear-off portion can be removed, forming an opening providing access to the pocket within the elongate body. The flat bottom edge has a bottom edge length, a height being defined as a minimum distance from the bottom edge to the perforation line, and the bottom edge length is at least three times the height. The pocket is sized and configured to accommodate a hot dog therewithin, and when the tear-off portion is removed the pocket is enclosed except at the perforation line.

In accordance with a further embodiment a pocket bread is provided comprising a flatbread body having a circumferential edge extending about the body, a pocket being formed within the flatbread body. A perforation line is adjacent a first portion of the circumferential edge, and a tear-off portion is defined between the perforation line and the first portion of the circumferential edge. The perforation line is aligned with a second portion of the circumferential edge. An offset portion of the circumferential edge joins the first and second portions of the circumferential edge, the offset portion being directed generally outwardly from the flatbread body. The pocket bread preferentially tears along the perforation line so that the tear-off portion can be removed, forming an opening providing access to the pocket within the elongate body.

In some embodiments the flatbread body is elongate and has an upper edge and a lower edge, and the tear-off portion extends along only a portion of the upper edge.

### BRIEF DESCRIPTION OF THE DRAWINGS

FIG. 1 is a schematic perspective view of a pita bread manufacturing system.

FIG. 2 is a close-up perspective view of a portion of the pita manufacturing system showing pita breads being die cut from a sheet of pita dough on a conveyor.

FIG. 3 shows pita bread in successive states during the manufacturing process, including showing an unbaked die cut dough, a bread shown inflated while baking, and the deflated state after baking.

FIG. 4 shows a pita bread configured in accordance with the one embodiment.

FIG. 5 shows the pita bread of FIG. 4 being opened by a user/eater.

FIG. 6 shows the pita bread of FIG. 4 being used as a bun portion of a hamburger sandwich having fixings.

FIG. 7 is a schematic view of a pita bread hamburger bun configured in accordance with an embodiment.

FIG. 8A is a close-up view showing one embodiment of an edge of a pita bread similar to that shown in FIG. 7, taken along line 8A-8A of FIG. 7.

FIG. 8B shows another embodiment of a pita bread edge taken from the same view as FIG. 8A.

FIG. 9 is a schematic view of a pita bread configured in accordance with another embodiment.

FIG. 10 is a schematic view of a pita bread configured in accordance with a further embodiment.

FIG. 11 is a schematic view of a pita bread embodiment that can be split into two pita sandwich buns in accordance with a preferred embodiment.

FIG. 12 is a schematic view of still another pita bread embodiment.

FIG. 13 is a schematic view of a still further pita bread embodiment.

FIG. 14 is a schematic view of yet another pita bread embodiment.

FIG. 15 is a schematic view of a pita bread embodiment configured for use as a hot dog bun.

FIG. 16 is a schematic view of another embodiment of a pita bread for use as a hot dog bun.

FIG. 17 is a schematic view of yet another embodiment of a pita bread for use as a hot dog bun.

FIG. 18 is a schematic view of still another embodiment of a pita bread for use as a hot dog bun.

FIG. 19 is a cutaway view of the embodiment of FIG. 18, showing a hot dog and several fixings piled into the pita pocket.

FIG. 20 is a schematic view of another embodiment of a pita bread for use as a hot dog bun.

FIG. 21 is a schematic view of a still further embodiment of a pita bread for use as a hot dog bun.

FIG. 22 is a close-up perspective view of another embodiment of a manufacturing system in which pitas are die cut from a flat dough on a conveyor in a first step and a rupture line is added to the die cut pita dough in a second step.

### DETAILED DESCRIPTION

This specification presents and discusses several nonlimiting embodiments of pocket breads, broadly referred to as pita breads. Such pocket or pita breads are flatbreads defining a pocket therewithin, which pocket is formed during manufacturing as a result of the unique character of pocket bread dough makeup, processing, and baking procedures.

With initial reference to FIG. 1, a system for manufacturing and baking pita breads having characteristics as in the embodiments described herein is disclosed. The system is a manufacturing line. It is to be understood that other systems and methods can be employed for making pita breads. However this system is presented to give a background and perspective on the pita breads.

In the illustrated embodiment, the pita manufacturing system 30 begins with a hopper 34 into which dough can be placed. The hopper 34 preferably spreads the dough generally flat onto a conveyor 38. A rolling apparatus 40 may be used to roll the dough so as to ensure the desired thickness and flatness of the dough as it moves with the conveyor. In this embodiment, the flat dough 41 on the conveyor 38 is communicated into a warm proofer 42 within which the dough is encouraged to rise. Upon exiting the proofer onto another conveyor 46, the dough can be further rolled by a second rolling apparatus 44 so that the dough is relatively thin. The fully rolled dough 45 preferably proceeds through a die cutting apparatus 48 which die cuts pita dough portions 50 from the flat dough of the conveyor. Once the pita dough portions 50 have been die cut, they preferably are conveyed into another proofer 60, which allows them to rise yet again. Upon exiting the second proofer 60, preferably the pita dough portions are transferred to an oven conveyor 63, which transports the pita dough through an oven 66.

Preferably the oven 66 is operated under parameters so that when the pita dough portion enters the oven, preferably the oven is sufficiently hot to sear the outer crust of the pita, thus sealing an outer skin of the pita. As the pita dough continues to heat, water and other gases within the dough, and particularly within the center of the dough, expand greatly. Due to these expanded gases dough adjacent a first side of the pita is separated from dough adjacent an opposing second side of the pita. Since the dough is baked when separated in this manner, an enduring pocket is formed within the pita. During baking, usually pressure within the pita becomes great enough to rupture the pita skin so that the expanding gases can escape.

After leaving the oven 66, a conveyor 68 transports the baked pitas to a cooling tower 70, which enables the baked pitas to cool sufficiently for packaging. As such, the next step of the manufacturing line is for the pitas to be delivered to a packaging station 72, where they are packaged for delivery to customers.

With reference next to FIG. 2, a close-up view of one embodiment of a dough cutting apparatus is shown. In this embodiment, conveyor 46 conveys fully rolled dough 45 through a die cut roller having several dies that are shaped in accordance with a desired pita shape. The die cut roller rolls 48 over the fully rolled dough 45, die cutting pita dough portions 50 from the sheet of dough. As shown in FIG. 2, excess dough 52 between the die cut portions 50 preferably is lifted onto an upwardly-directed conveyor 54 that directs the dough away from conveyor 46 on which the die cut pita dough portions 50 remain. The surplus dough 52 is conveyed by the upwardly-directed conveyor 54 to a transverse-directed conveyor 56, which transports the dough to a container 58 on the side of the conveyor 46. The excess dough may eventually be returned to the hopper 34 during continued manufacture. The die cut pita dough portions 50, however, continue along the conveyor to the second proofer 60 as discussed above in connection with FIG. 1.

FIG. 3 depicts a die cut pita 50 as initially cut, inflated during baking, and deflated again after cooling. In the illustrated embodiment, the die cut process includes forming a perforation line 80 across the pita dough. The perforation line is formed in flexible, resilient dough. Thus, the dough generally rebounds so that the perforation more closely resembles scoring in the dough. However, during baking, when the pita 50 is inflated and the skin of the pita is under pressure, the perforation line is generally weaker than other contiguous points along the pita. As such, the pita preferentially ruptures along the perforation line 80. As a result, other parts of the pita remain intact, forming a pocket that is intact and enclosed except at the perforation line.

With reference next to FIG. 4, a pita sandwich bread 50 having features in accordance with a preferred embodiment comprises a body 82 flanked by generally-parallel opposing side edges 84, 86. A generally straight top edge 88 connects the side edges 84, 86 at one end. An arcuate bottom edge 90 connects the side edges at another. The perforation line 80 is spaced a short distance d from the top edge 88 and extends all the way from one side edge 84 to the other 86. Preferably the perforation line 80 is spaced from the top edge 88 a distance d at least as great as the thickness of the baked pita bread at the adjacent top edge. More preferably the distance is about the same as a finger, so a person can take hold of the edge and tear along the perforation line 80 to remove the edge 88 and expose an opening 96. A tear-off portion 100 is thus defined between the perforation line 80 and the top edge 86, and the top edge 88 in this embodiment can also be considered a tear-off edge.

With reference next to FIG. 5, and as just mentioned, since the pita 50 is preferentially weakened along the perforation line 80, preferably it is predisposed and relatively easy to open the pita adjacent the top edge 88 by simply tearing along the perforation line. By tearing the pita along the perforation line, the tear off portion 100 is removed, thus revealing an opening 96 that provides access to the pocket. Preferably the opening 96 is at the perforation line 80.

Some embodiments may have no perforation line, a perforation that is not formed into a line, and/or a partial perforation line that does not extend between the opposing sides. Nevertheless, an end user may still remove the tear off portion 100 by cutting or carefully tearing the bread adjacent the top edge, thus revealing the opening 96.

With reference next to FIG. 6, once the top edge 88 is removed with the tear off portion 100, access to the pocket is quite simple, and thus the pita 50 can be used for making a sandwich. In the illustrated embodiment, the pita is shaped and configured so that a circular hamburger patty 102 can easily be advanced through the opening 96 and into the pocket. Similarly, fixings 110 such as condiments like ketchup 112 and mustard 114, and further fixings such as cheese 116, lettuce 118, tomato 120, pickles 122, onions 124 and more can be advanced through the top opening and into the pocket. Of course, it is to be understood that many types of fixings 110 can be used. In the illustrated embodiment, mushrooms 126 are also added to the hamburger sandwich. All of the fixings 110 are held within the pocket of the pita. Further, the bottom arcuate edge 90 of the pita 50 generally follows the arcuate edge of the hamburger patty 102 so that the fixings and hamburger patty can accompany the pita in every bite.

FIG. 7 is a schematic representation of one embodiment of the pita 50 sandwich bread. In this embodiment, the opposing side edges 84, 86 are elongate and parallel to one another. The top edge 88 extends between ends of the side edges and forms about a right angle with each side edge 84, 86 in the illustrated embodiment. The top edge 88 preferably has a width W. The perforation line 80 preferably is parallel to the top edge and spaced closely thereto. An axis A in FIG. 7 denotes an axis of the curvature of the bread bottom edge 90. Preferably the axis A is chosen and placed to also generally align with an axis A of a circular hamburger patty 102 when the patty is fit within the pita pocket. The dashed lines represent the circular hamburger patty 102 within the pita pocket.

With continued reference to FIG. 7, R1 represents the radius of the hamburger patty 102. R2 represents the radius of the arcuate bottom edge 90 of the pita 50. In the illustrated embodiment, the arcuate bottom edge 90 extends about 180° about the axis A, and is a constant radius. Preferably R2>R1 so that a space 112 is defined between the edge of the pita and the edge of the patty. Such space 112 preferably is chosen so as to accommodate fixings 110 and to allow for the bending and opening of the bread in the pocket immediately adjacent the bottom edge of the pita. The axis A is spaced a distance D1 from the perforation line 80 and a distance D2 from the top edge 88. Preferably D1>=R2, and more preferably D1 is about the same as or marginally greater than R2. As such, the patty 102 will fit fully within the pita pocket even after the tear away portion 100 is removed at the perforation line. Preferably the width W of the opening at the top edge 88 or perforation line 80 is at least two times R1 (W>=2R1), which is the radius of the meat patty 102. More preferably, the width W is at least two times R2 (W>=2R2), and most preferably W is about the same as two times R2. As such, the opening is large enough to slide the patty through the opening and into the pocket, but not so large that there is excess bread.

In some embodiments, structure can be provided to facilitate tearing the top edge 88 off the baked pita 50 along the perforation line 80 so as to open the pita pocket. With reference next to FIG. 8A, in one embodiment, during the die cutting process, the die cuts the perforation line 80 but also cuts a notch 114 at the side edge 84 and aligned with the perforation line. As such, when a user grasps the top edge 88 and pulls, the perforation line 80 readily tears, enabling relatively easy tearing of the tear-off portion 100 from the body 82 of the pita. FIG. 8B shows another embodiment in which a tab portion 116 at and adjacent the top edge extends outwardly from the side edge 84 at the perforation line 80. As such, it will be easy for a user to identify where the edge 84 should be torn, and it will be comparatively easy to correctly start the tear-off process. As discussed above, due to the perforation line 80, preferably the top edge 88 can be relatively easily torn from the rest of the pita 50, creating an opening that provides access to the pita pocket.

In the embodiments shown in FIGS. 8A and 8B, structure is provided that creates a stress concentration point 118 at the intersection of the side edge 84 and perforation line 80. It is to be understood that other structures are contemplated that can create such a stress concentration that would preferentially start at tear at the perforation line.

With reference to FIG. 9, another embodiment of a pita 50 for a hamburger sandwich is substantially the same as the embodiment in FIG. 7 except that the top edge 88 is arcuate so as to be convex relative to the rest of the pita body 82. The perforation line 80 preferably shares the same arc. This construction acknowledges that when the pita is opened, the opening edge of the pita is deflected outwardly to fill the pita pocket. The degree of arc is chosen to compensate for that deflection so that a middle portion of the opening edge is not effectively lower than the rest of the top edge upon deflection. The convex arc also can enable greater height to support a higher volume of fixings near a middle of the pita pocket opening.

With reference next to FIG. 10, yet another embodiment is illustrated schematically. In this embodiment, the side edges 84, 86 are not parallel to one another, but instead diverge outwardly moving toward the top edge 88 of the pita 50. As with other embodiments, preferably the illustrated embodiment has an axis A shared by the circular patty 102 in the pocket and the arcuate bottom edge 90. The radius R1 of the hamburger patty 102 is less than the radius R2 of the arcuate bottom edge 90 of the pita. However, R2 does not complete a full 180° about the axis A. Instead angle theta (θ) is less than 180°. A distance D2 is defined from the top edge to the point on the edge at which the bottom edge 90 stops following radius R2 and becomes the straight side edge 84. D1 is defined from that point to the perforation line 80. A width W of the top edge 88 preferably is greater than twice the radius R2. Similarly, preferably distance D1>R2.

With continued reference to FIG. 10, in some embodiments, the side edges 84, 86 can diverge dramatically relative to one another. However, in the illustrated embodiment, the side edges 84, 86 only mildly diverge. In this embodiment, a divergence distance δ is defined as the transverse distance between the point at which the side edge 84 intersects the perforation line 80 and the point at which the bottom edge 90 stops following radius R2. Preferably, a ratio of D1:δ is greater than about 4:1. In another embodiment D1:δ is greater than about 5:1. Preferably the diverging side edges 84, 86 enable the opening at the perforation line 80 to be widened to facilitate easier loading of the meat patty and fixings into the pita pocket.

With reference next to FIG. 11, another embodiment is illustrated in which a single pita 140 is formed to have, basically, two of the shapes of FIG. 7 joined at a single perforation line 80. Thus, as the pita 20 is torn in half at the perforation line 80, the user will be left with two hamburger-ready pita breads that have an opening and which resemble embodiments discussed herewithin, but with the tear-away portion removed.

With reference next to FIG. 12, another embodiment of a pita 50 for accommodating a circular hamburger patty and associated fixings is illustrated. In the illustrated embodiment, the top edge 88 is arcuate. It is also offset relative to the bottom arcuate edge 90 by offset edges 142. The end of the perforation line 80 adjacent the top edge 88 is generally aligned with the arcuate bottom edge 90. In the illustrated embodiment, a diverging tab portion 144 of the top edge 88 at the offset edges 142 provides purchase for a user to tear the top edge off the body along the perforation line. The tab 144 and the offset top edge 88 assist a user in easily tearing away the top edge tear-away portion 100 at the arcuate perforation line 80.

In this embodiment, much of the pita pocket is open once the tear-away portion removed. For example, the arcuate perforation line extends about 180° around axis A. In other embodiments the top edge may be arcuate over a range of about 150-180°.

In the embodiment illustrated in FIG. 12 the arcuate bottom edge 90 does not follow a constant radius. For example, radius R3 is greater than radius R2. Further, preferably the radius of the bottom edge 90 increases between R2 and R3. As such, there is extra space at the bottom of the pocket to accommodate the meat patty and additional fixings, as this embodiment provides extra depth.

With reference next to FIG. 13, another embodiment is shown having the arcuate top edge 88 and offset edges 142. The arcuate perforation line 80 is generally aligned with the arcuate bottom edge 90. In the illustrated embodiment, however, R2<R1. More specifically, preferably the bottom arcuate edge 90 of the pita 50 has a generally constant radius R1 over about 180°. However, at the very top of the perforation line, the radius R2 is greater than R1. Further, the radius increases moving from the side toward the topmost point of the perforation line.

With reference next to FIG. 14, another embodiment is illustrated having an offset top edge tear-off portion 100. However, in this embodiment, a first axis A1 is provided about which the bottom arcuate edge 90 curves generally along radius R1 for about 180°. A second axis A2 is offset a distance d from axis A1. The arcuate perforation line 80 in the illustrated embodiment curves about axis A2 along a constant radius R2 for about 180°. In the illustrated embodiment, R1=R2. Parallel opposing side edges 84, 86 extend between the arcuate portions 88, 90. In other embodiments, R2 may be different than R1. In embodiments in which R2>R1, the offset side edges 84, 86 will diverge relative to one another moving toward the top edge 88.

With reference next to FIG. 15, an embodiment of a pita hot dog bun 150 is illustrated. The illustrated hot dog pita 150 preferably has an elongate body 151 having a top edge 152 and a perforation line 80 spaced from and adjacent to the top edge 152 so as to enable easy tearing the pita 150 of the perforation line 80 to remove a tear-off portion 100 and form a pocket opening at the perforation line 80 as in the embodiments discussed above in connection with hamburger pitas. Opposing side edges or ends 154, 156 can be substantially parallel to one another, and extend from the top edge 152 to a bottom edge 158. Preferably there is a curving transition 159 between the bottom edge 158 and each side edge 154, 156. Preferably the elongate body 151 has a length L sufficiently long so that a hot dog 160 can be accommodated within the pocket of the pita 150 with some space available at each end. Further, in order for the proportions to best fit a hot dog 160, a height H from the bottom edge to the perforation line preferably is less than about ⅓ of L, and more preferably less than about ¼ of L.

With reference next to FIG. 16, another embodiment of a hot dog pita 150 is similar to the embodiment just discussed in connection with FIG. 15 except that it has straight 90° transitions between the side edges 154, 156 and the bottom edge 158.

With reference next to FIG. 17, another embodiment of a hot dog pita 150 is provided that is very similar to the embodiment discussed above in connection with FIG. 15, except that the top edge 152 is generally convexly arcuate and the perforation line 80 is arcuate so as to generally follow the arcuate top edge.

Importantly, some structures discussed above in connection with hamburger pitas can also be used with hot dog pitas, including features such as a notched tear starter or other structure for creating a stress concentration point on the side edge aligned with the perforation line, such as a tab, offset or other structure configured to aid tearing of the top edge.

With reference next to FIG. 18, another embodiment of a hot dog pita 150 comprises an arcuate top edge 152 and correspondingly arcuate perforation line 80. In this embodiment a length L1 of the top edge 152 is greater than a length L2 of the bottom edge 158. As such, side edges 154, 156 of the hot dog pita 150 are divergent outwardly moving from the bottom edge 158 toward the top edge 152. FIG. 19 shows a section view of the embodiment of FIG. 18 showing a hot dog 160 and several fixings 110 held within or by the pita pocket. As shown, the ends 154, 156 of the hot dog pita are closed. As such, fixings 110 are less likely to drip or otherwise fall out of ends of the hot dog pita 150 than they would with a typical hot dog bun. Additionally, in the illustrated embodiment in which these side edges 154, 156 are divergent outwardly moving toward the top edge, the pita pocket is able to accommodate a relatively large volume of fixings all the way to and beyond the ends of the hot dog 160 itself without the fear of such fixings falling out, as would be the case with a conventional bun.

With next reference to FIGS. 20 and 21, additional embodiments are illustrated in which a tear away edge 100 including an accompanying perforation line 80 extends along less than the entire length of the top edge 152 of the pita 150. For example, in the embodiment illustrated in connection with FIG. 20, the tear away edge 100 extends along a portion of a bottom edge 158 of the pita, around one side edge 154 of the pita, and along more than half but less than all of the top edge 152 of the pita. As such, when the tear-off portion 100 is removed, the pita 150 will be mostly open along one of its ends and closed at the other of its ends. This embodiment may enable a user to eat the pita hot dog sandwich starting at the generally open end 154 and working his way toward the closed end 156. The closed end will remain closed, preventing its fixings from escaping or dripping out of the pita. Similarly the embodiment illustrated in connection with FIG. 21 has a tear away edge portion 100 that begins with a tab 144 at one side edge 154 that extends about three quarters of the length of the top edge 152. This configuration provides still more security for holding the hot dog and fixings within the pocket.

With reference next to FIG. 22, another embodiment of a die cutting system is illustrated. This embodiment is quite similar to the embodiment discussed above in connection with FIG. 2. However, in this embodiment, a die cutting roller 48 cuts the shape of the pita out of the dough sheet 45, but does not cut the perforated line. Instead, perforating disks 166 rolling over the conveyor cut the perforation lines 80 into the die cut pitas 50. It is to be understood, however, that several manufacturing processes can be used to make pitas having perforation lines that extend from side to side along the top edge of the pita and which enable preferential tearing of the pita along the perforation line. Also, pitas having features as described herein can be manufactured without perforations, or with differently-configured perforations.

Most of the embodiments discussed above include a perforation line and contemplate that a user will tear off a portion of the pita bread at the perforation line. In other embodiments a pita may be sliced to remove an edge, such as a top edge, prior to being packaged. As such, when the user removes the pita from its package, the opening will already be in place. For example, in one embodiment, after baking and cooling, but before packaging, a worker individually cuts each pita to remove an edge and create an opening using a knife, roller cutter or the like. In other embodiments several pitas may be stacked, preferably using a form to provide consistent alignment, and then a worker may use a cutter to cut off a tear off portion of the group of pitas in one operation, thus creating the opening in each of the pitas. The entire group of pitas may then be packaged together, or the group may be divided into subgroups for packaging. It is to be understood that pita breads that are cut during manufacture may or may not be initially formed with perforations.

Although this invention has been disclosed in the context of certain preferred or illustrated embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the disclosed embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

What is claimed is:

1. A pocket bread, comprising:
a flatbread body having opposing first and second faces and a circumferential edge surrounding the flatbread body and connecting the first and second faces, a pocket being formed within the flatbread body, the circumferential edge comprising an arcuate bottom edge portion, opposing first and second side edge portions extending from opposing ends of the arcuate bottom edge portion, and a top edge portion connecting the opposing side edges;
the arcuate bottom edge portion curving up to 180° about an axis and having a radius; and
a tear off portion defined adjacent the top edge portion and extending from the first side edge portion to the second side edge portion, the tear off portion configured so that when the tear off portion is removed, an opening is formed that provides access to the pocket within the body, the opening defined by a first opening edge of the first face and a second opening edge of the second face;
wherein a minimum distance from the axis to the perforation line is at least as great as the radius of the arcuate bottom edge portion.

2. A pocket bread as in claim 1 additionally comprising a perforation line adjacent the top edge portion and extending from the first side edge portion to the second side edge portion, wherein the tear off portion is defined between the top edge portion and the perforation line.

3. A pocket bread as in claim 2, wherein the first and second side edge portions are parallel.

4. A pocket bread as in claim 2, wherein the first and second side edge portions are divergent moving in a direction toward the top edge portion.

5. A pocket bread as in claim 2, wherein the top edge portion is flat.

6. A pocket bread as in claim 2, wherein the top edge portion is arcuate, and the perforation line is correspondingly arcuate.

7. A pocket bread as in claim 2, wherein a stress concentration point is located at the intersection of one of the first and second side edge portions and the perforation line.

8. A pocket bread as in claim 7, wherein a notch is formed in one of the first and second side edge portions and aligned with the perforation line, and wherein the stress concentration point is at the notch.

9. A pocket bread as in claim 2, wherein a tab portion extends outwardly from one of the first and second side edge portions between the perforation line and the top edge portion.

10. A pocket bread as in claim 9, wherein a bottom edge of the tab portion is generally aligned with the perforation line.

11. A pocket bread, comprising:
an elongate flatbread body having a circumferential edge extending about the elongate body, a pocket being formed within the elongate flatbread body, the circumferential edge comprising a first end, a second end, a top edge and a flat bottom edge,
a perforation line adjacent the top edge and extending from the first end to the second end, a tear-off portion defined between the perforation line and the top edge, the pocket bread preferentially tearing along the perforation line so that the tear-off portion can be removed, forming an opening providing access to the pocket within the elongate body; and
the flat bottom edge having a bottom edge length, a height being defined as a minimum distance from the bottom edge to the perforation line, the bottom edge length being at least three times the height;
wherein the pocket is sized and configured to accommodate a hot dog therewithin, and when the tear-off portion is removed the pocket is enclosed except at the perforation line.

12. A pocket bread as in claim 11, wherein the first and second ends comprise respective first and second edges that extend from the bottom edge to the top edge.

13. A pocket bread as in claim 12, wherein the first and second edges are generally parallel to one another.

14. A pocket bread as in claim 12, wherein the first and second edges are divergent away from one another moving from the bottom edge toward the top edge.

15. A pocket bread, comprising:
a flatbread body having a circumferential edge extending about the body, a pocket being formed within the flatbread body;
a perforation line adjacent a first portion of the circumferential edge, a tear-off portion being defined between the perforation line and the first portion of the circumferential edge, the perforation line being aligned with a second portion of the circumferential edge, an offset portion of the circumferential edge joining the first and second portions of the circumferential edge, the offset portion being directed generally outwardly from the flatbread body;
the pocket bread preferentially tearing along the perforation line so that the tear-off portion can be removed, forming an opening providing access to the pocket within the elongate body.

16. A pocket bread as in claim 15, wherein the flatbread body is elongate and has an upper edge and a lower edge, and the tear-off portion extends along only a portion of the upper edge.
